(19) United States
(12) Patent Application Publication
(10) Pub. No.: US 2009/0036098 A1
(43) Pub. Date: Feb. 5, 2009

(54) CELL SEARCHING METHOD AND MOBILE TERMINAL THEREFOR

(75) Inventors: Hyeong Su LEE, Yongin-si (KR); Ramanag VENKATA, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/182,916

(22) Filed: Jul. 30, 2008

(30) Foreign Application Priority Data
Jul. 30, 2007 (KR) 2007-0076515

(51) Int. Cl. H04M 1/66; H04Q 7/20

(52) U.S. Cl. 455/411; 455/435.2

(57) ABSTRACT

A cell searching method and mobile terminal for a mobile communication system is provided. The terminal and method facilitate cell searching by using a database that registers cell information, such as frequencies and identities. A cell searching method of a mobile terminal according to the present invention includes determining whether authentication information of at least one cell exists in a memory, selecting, when the authentication information exists, the authentication information of the at least one cell, evaluating validity of the selected authentication information and attempting to camp on the cell using the authentication information if the validity evaluation is successful.

### PRIORITY

This application claims the benefit under 35 U.S.C. §119(a) of a Korean parent application filed in the Korean Intellectual Property Office on Jul. 30, 2007 and assigned Serial No. 2007-0076515, the entire disclosure of which is hereby incorporated by reference.

### BACKGROUND OF THE INVENTION

1. Field of the Invention

The present invention relates to a mobile communication system. More particularly, the present invention relates to an apparatus and method in a mobile communication system that is capable of facilitating cell searching by using a database to register cell frequencies and identities.

2. Description of the Related Art

With the advance of wireless technologies, mobile terminals such as cellular phones have been improved regarding their portability and their data carriage capability. Accordingly, the use of mobile terminals has increased dramatically in the past decade and they have become an essential tool for communication. Specific improvements of mobile terminals include the support of various types of data communications as well as voice and message communications. In order to use a data communication service, a user should subscribe to the data communication service provided by a communication service provider. Such a subscription provides the mobile terminal access to the data communication service in the radio coverage service area of a base station.

When a mobile terminal is turned on or enters a service area, it performs a search to find a cell of a base station. That is, the mobile terminal performs channel scanning to detect and receive a signal transmitted by a base station of the subscribed data communication service provider. At this time, the mobile terminal scans all frequency bands to select a proper base station. Once selected, the mobile terminal finds a center frequency of the base station and then performs authentication via the base station. If the mobile terminal passes the authentication test, it camps onto the base station. However, if the mobile terminal fails the authentication test or the camping-on process, it must re-scan all the frequency bands and re-perform all of the processes following the scanning. With such repeated scanning, the mobile terminal wastes battery power as well as time and experiences a significant processing load to enable a connection to the base station.

### SUMMARY OF THE INVENTION

An aspect of the present invention is to address at least the above-mentioned problems and/or disadvantages and to provide at least the advantages described below. Accordingly, an aspect of the present invention is to provide a network discovery method and mobile terminal that is capable of improving cell searching efficiency by allowing the mobile terminal to perform cell searching at a highly available area.

In accordance with an aspect of the present invention, a cell searching method of a mobile terminal is provided. The method includes determining whether authentication information of at least one cell exists in a memory, selecting, when the authentication information exists, the authentication information of the at least one cell, evaluating validity of the selected authentication information and attempting to camp onto the cell using the authentication information if the validity evaluation is successful.

In accordance with another aspect of the present invention, a mobile terminal is provided. The mobile terminal includes a memory unit for storing authentication information of at least one cell for use in a cell searching, a control unit for selecting authentication information of one of the at least one cell, for evaluating validity of the authentication information, and for attempting a camp-on to the cell using the authentication information, if valid and a radio frequency unit for establishing a communication channel with the cell on the basis of the authentication information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a block diagram illustrating a configuration of a mobile terminal according to an exemplary embodiment of the present invention;

FIG. 2 is a diagram illustrating an authentication information database according to an exemplary embodiment of the present invention;

FIG. 3 is a temporal flow diagram illustrating steps of a cell searching method according to an exemplary embodiment of the present invention;

FIG. 4 is a flowchart illustrating a cell searching method according to an exemplary embodiment of the present invention; and

FIG. 5 is a flowchart illustrating an exemplary camping-on procedure of FIG. 4 in more detail.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and convenience.

The terms and phrases used in the specification and appended claims are provided to enable a clear and consistent understanding of the detailed description and the claims. Unless otherwise noted, the terms and phrases are to be understood according to conventional usage by those skilled in the relevant art. While the invention is shown and described with reference to certain exemplary embodiments thereof, it will be understood by those skilled in the art that various changes in form and details may be made therein without departing from the spirit and scope of the invention as defined by the appended claims.

In the following, the cell searching is performed with reference to an authentication information database stored in the memory. In order to improve the cell searching efficiency according to an exemplary embodiment of the present invention, the mobile station retrieves valid authentication information among the authentication information provided by the database, performs the cell searching procedure with a network indicated by the valid authentication information a restricted number of times, and, when failing all the authentication tests, performs network scanning of all frequency bands. Although the cell searching method and mobile terminal therefor is described with a specific number of authentication parameters, a specific number of scanning repetitions, and a specific period of the scanning in the following description, the present invention is not limited thereto.

Furthermore, although the cell searching method and mobile terminal are described in association with a Global System for Mobile communications (GSM), the present invention is not limited thereto. For example, the cell searching method and mobile terminal can be applied to other 2G systems such as Code Division Multiple Access (CDMA), 2.5G systems such as General Packet Radio Service (GPRS), 3G systems such as Universal Mobile Telephone System (UMTS) and CDMA2000, their equivalents and any combination of them.

It is noted that the number of cell searching times and cell searching intervals used in the following exemplary embodiments can be adjusted according to the geographic features of the location in which the mobile terminal is used, communication system to which the mobile terminal is applied, design characteristics of the mobile terminal, system operator's requirements and the like.

In the following description, the mobile terminal can be any of mobile communication terminals including a Time Division Multiple Access (TDMA) terminal, a GSM terminal, a CDMA terminal, a WCDMA terminal and the like; multimedia devices such as a Portable Multimedia Player (PMP), an MP3 player, a digital broadcast receiver having cellular communication functions; a Personal Digital Assistant (PDA), a Smartphone, and their equivalents.

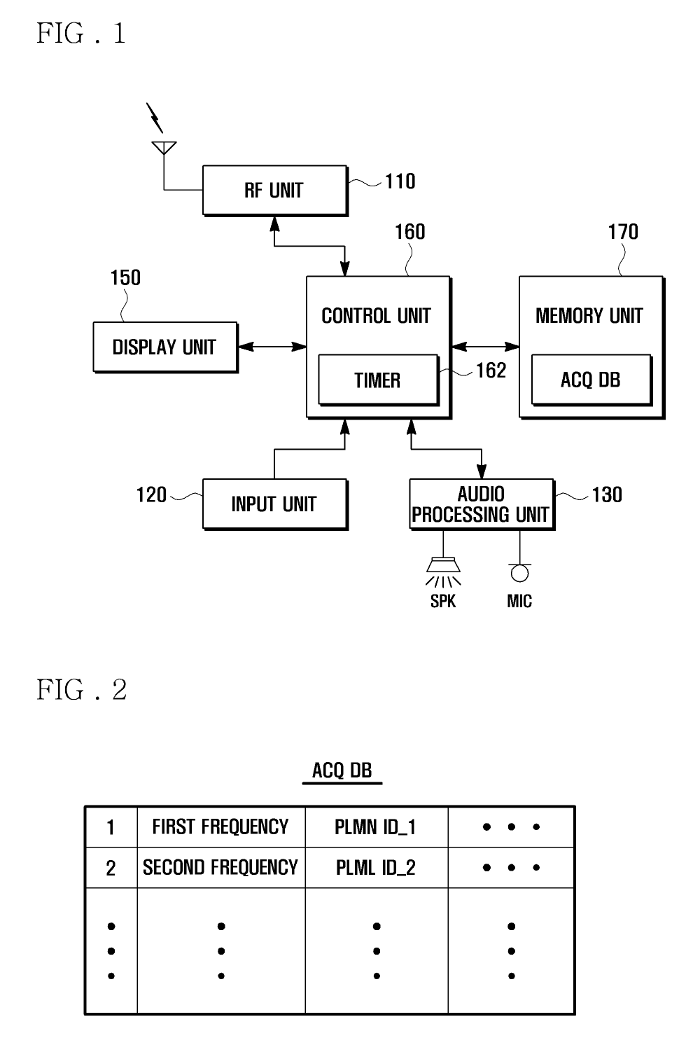

FIG. 1 is a block diagram illustrating a configuration of a mobile terminal according to an exemplary embodiment of the present invention.

In an exemplary implementation, the mobile terminal uses frequency, Public Land Mobile Network identity (PLMN ID), and Cell ID for identifying the base station. The mobile terminal scans and selects an available frequency and acquires the PLMN ID and Cell ID from a System Information Block (SIM) or Master Information Block (MIB) transmitted by a base station. After establishing a communication channel with a specific base station, the mobile terminal determines if it can acquire information on the frequency, PLMN ID, Cell ID, and other information extracted from the SIM or MIB received from the base station.

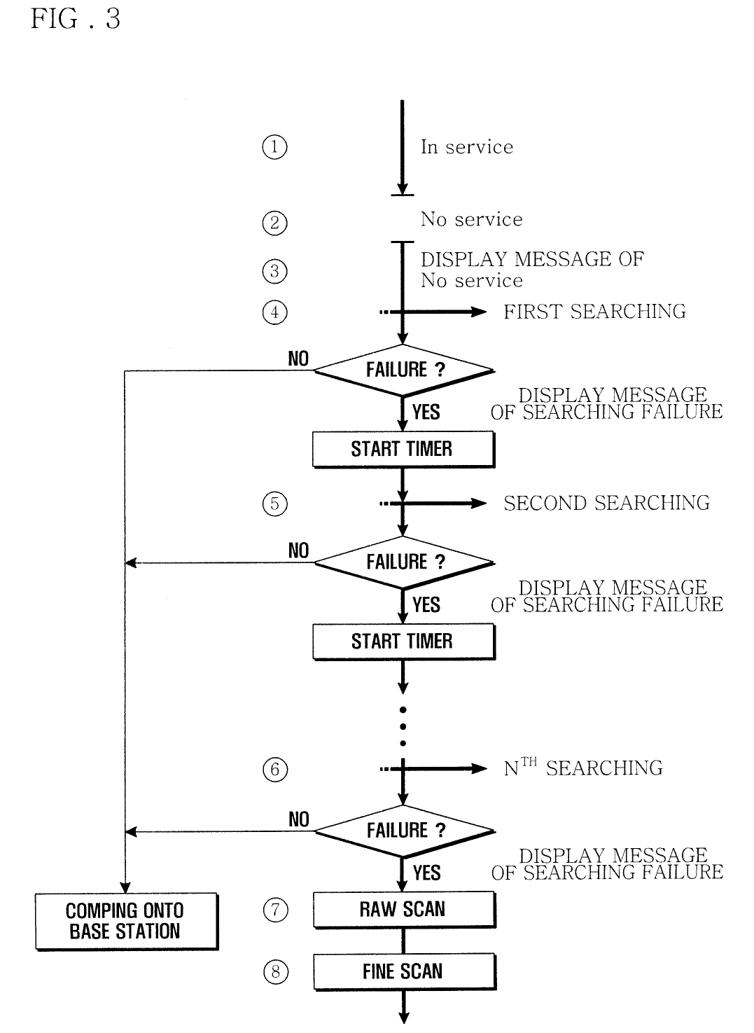

Referring to FIG. 1, the mobile terminal includes a Radio Frequency (RF) unit 110, an input unit 120, an audio processing unit 130, a display unit 150, a memory unit 170, and a control unit 160. The mobile terminal scans frequency bands by means of the RF unit 110 in order to detect available frequency bands and establishes a communication channel with a base station using one of the available frequency bands. Once established, the mobile terminal stores the authentication information required for establishing the base station in the form of an All Call Query (ACQ) DB as illustrated in FIG. 2.

The RF unit 110 is responsible for establishing a radio channel with the base station. Once established, the radio channel is used for data and voice communications with the base station by the mobile terminal under the control of the control unit 160. The RF unit 110 can transmit radio signals carrying the user data to a receiving terminal through the radio channel. In an exemplary implementation, the RF unit 110 scans frequency bands and performs a procedure for collecting more detailed information on the detected frequency bands under the control of the control unit 160. When the mobile terminal is powered on, locates in a shadow area of the base station, or moves from the shadow area to a service area of the base station, the RF unit 110 performs a first scan (raw scan) so as to detect the frequency bands of the base stations around it. At this time, the frequency information collected by the raw scan is rough. Next, the RF unit 110 performs a second scan (fine scan) for detecting center frequencies of the detected frequency bands. Here, the information of the base station to which the mobile terminal is connected is stored within the memory unit 170 in the form of the ACQ DB. Or, if previous information is already stored in the ACQ DB, the mobile terminal updates the ACQ DB with the more recent information. In a case that the ACQ DB exists in the memory unit 170, the RF unit 110 attempts a network connection to the base station a number of times.

The input unit 120 is provided with a plurality of alphanumeric keys for inputting of alphanumeric data and function keys for executing various functions of the mobile terminal. In an exemplary embodiment, the function keys include navigation keys, side keys, shortcut keys and the like. The input unit 120 generates a key signal in response to a key input and sends the key signal to the control unit 160. In an exemplary implementation, the key input unit 120 generates power-on and power-off signals for turning on and off the mobile terminal and generates a channel establishment request signal for initiating the channel establishment procedure with the base station. The input unit 120 can generate key signals for requesting data communication and message transmission.

The audio processing unit 130 processes audio data input from the control unit 160 so as to output the audio through a speaker (SPK) in the form of an audible sound wave and processes an audio signal input through a microphone (MIC) so as to output the audio signal to the control unit in the form of audio data.

The display unit 150 displays various menu screens associated with applications of the mobile terminal and also displays data input by a user or provided for the user. The display unit 150 can be implemented with a Liquid Crystal Display (LCD). In a case that the LCD supports a touchscreen function, the display unit 150 can act as a part of the input unit 120. In an exemplary embodiment, the display unit 150 can be configured to display a status of the channel establishment procedure. As an example, when the mobile terminal powers on, the display unit 150 displays an initial screen and displays a search result on the screen when the terminal automatically performs cell searching. Here, the search result may include a search success message or a search failure message. When an available frequency is detected during the cell searching process, the display unit 150 may display a message indicating whether the mobile station is camping onto the base station. When the mobile station has successfully camped onto the base station, the display unit 150 may present an icon indicating a current frequency band. In a case that the mobile terminal fails the foregoing processes after attempting a number of times, the display unit 150 may display a message notifying that no available base station exists. The display unit 150 can also display option setting screens which allow the user to configure options associated with the cell searching method.

The memory unit 170 stores application programs for executing functions of the mobile terminal as well as user data produced by the user and generated by the mobile terminal, for example during a data communication. The memory unit 170 may be provided with at least one buffer for buffering application data generated while the application programs operate. In an exemplary embodiment, the memory unit 170 is provided with a storage area for storing the ACQ DB which is created and updated under the control of the control unit 160. The memory unit 170 may further be provided with separate program and data regions. If so provided, the program region stores an operating system and application programs of the mobile terminal while the data region stores user data and application data generated while the application programs operate and the ACQ DB.

The ACQ DB is composed of records of base stations, each including a frequency number, PLMN ID, and other information fields. The frequency number indicates a frequency band on which the mobile station may establish a communication channel with the corresponding base station. That is, the ACQ DB lists the frequency numbers and PLMN IDs of the base stations that are obtained during the network scanning procedure. The records of the base stations may be listed randomly or in a particular fashion. For example, the base stations may be listed in an ascending order of most recent to least recent. The ACQ DB, updated in this manner, is referred to for determination of a base station with which the mobile terminal may establish a communication channel.

The control unit 160 controls general operations and signaling among the internal components of the mobile terminal. The control unit 160 may incorporate a data processing function for the processing of data that is exchanged between the mobile terminal and the base station. In this case, the control unit 160 is responsible for processing the voice signal input by the audio processing unit 130, alphanumeric data input by the user through the input unit 120, and data received through the RF unit 110.

In an exemplary embodiment, the control unit 160 concentrates the network selection process using a specific frequency band and PLMN ID with reference to the ACQ DB stored in the memory. Such concentration reduces the scanning of unnecessary frequency bands and thus reduces the number of authentication attempts. The control unit 160 includes a timer 162 for reducing the repetition of cell searching times. That is, the timer 162 determines the cell searching interval. The searching procedure is described in more detail with reference to FIG. 3

FIG. 3 is a temporal flow diagram illustrating steps of a cell searching method according to an exemplary embodiment of the present invention.

Referring to FIG. 3, the mobile terminal is associated with a base station and served by the base station during a period of time \textcircled{1}. That is, the mobile station is in service. In time duration \textcircled{2}, the mobile terminal leaves the service area of the base station and is in a no-service situation. For example, the mobile terminal may power off, enter a shadow area or otherwise no longer be provided service from the base station. In an exemplary implementation, the mobile terminal may display a message indicating that the mobile terminal is out of the service area, on the display unit 150 during a period of time \textcircled{3}. Next, the mobile terminal performs scanning, cell selection, authentication, and camping onto the base station, at a preset time interval. For example, when entering a shadow area in which service from the base station is unavailable, the mobile terminal performs a first scanning at time \textcircled{4}. Here, the scanning, or searching, may include an authentication process with reference to frequencies and PLMN IDs listed in the ACQ DB and channel establishment process by camping onto the base station. That is, the mobile terminal selects one of frequencies listed in the ACQ DB and determines whether the selected frequency is available. If an available frequency exists, the mobile station performs camping onto the base station through the available frequency. That is, the mobile terminal performs an authentication with the base station to determine if the mobile terminal may receive the communication service provided by the base station. If the mobile terminal fails any of the above steps, it repeats the steps to all the frequency bands listed in the ACQ DB for establishing a communication channel. If the attempts to all the frequency bands fail, the mobile terminal displays a cell searching failure message on the display unit 150 and starts a timer. When the timer has expired, the mobile terminal performs a second scanning in the same manner as the first scanning at time \textcircled{5}. The scanning can be repeated N number of times. That is, the mobile terminal performs nth scanning (N is natural number) at time \textcircled{6}. If the N^{th} scanning has failed, the mobile terminal ignores the frequencies listed in the ACQ DB and sequentially performs a first scan (raw scan) at time \textcircled{7} and a second scan (fine scan) at time \textcircled{8} for detecting frequency bands and selects one of the detected frequency bands.

By scanning the frequency bands according to the above manner, the time spent on scanning can be reduced which in turn reduces the battery power consumption.

Although the mobile terminal is schematically depicted in FIG. 1, the present invention is not limited to the configuration of FIG. 1. For example, the mobile terminal may further include at least one of a camera module, a broadcast receiver module, and a multimedia module.

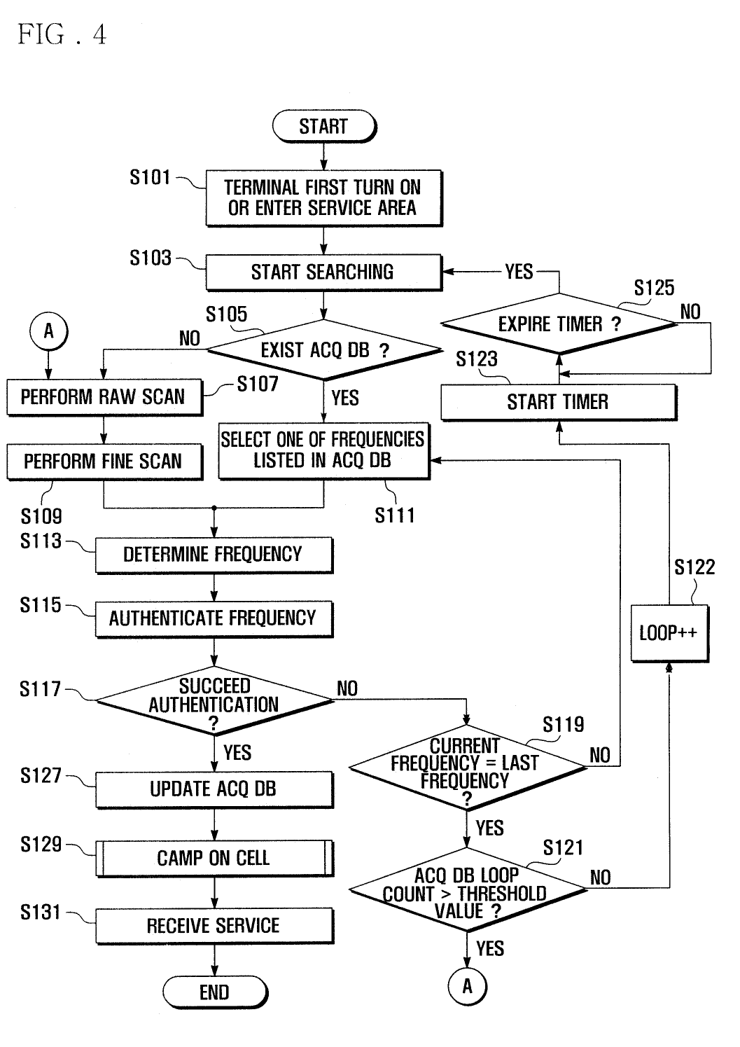

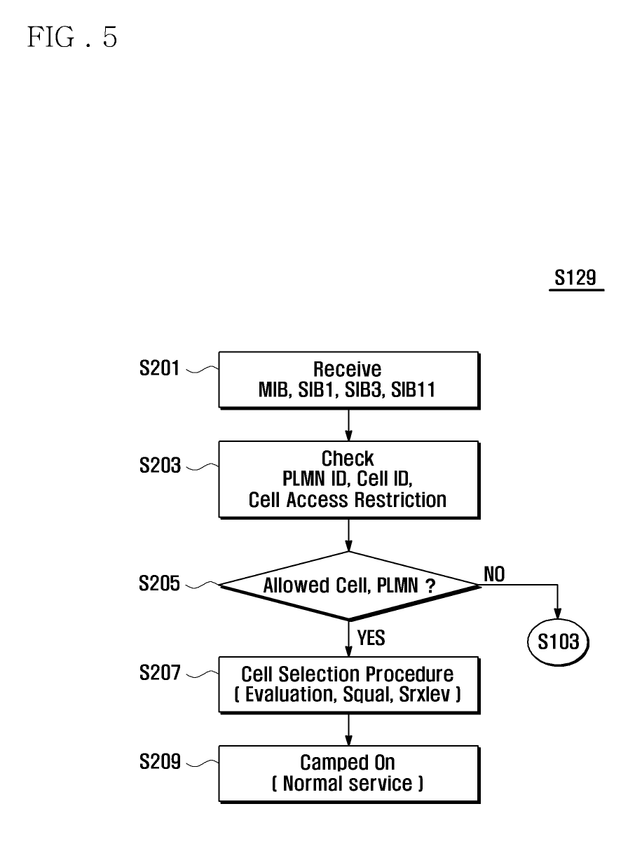

An exemplary cell searching method is described hereinafter with reference to FIGS. 4 and 5.

FIG. 4 is a flowchart illustrating a cell searching method according to an exemplary embodiment of the present invention.

Referring to FIG. 4, when the mobile terminal is first powered on or enters a service area that is served by a base station in step S101, it performs cell searching in step S103.

The searching process may be performed in a non-service area periodically. In the non-service area, however, the mobile terminal does not proceed to the processes following the network scanning since no available frequency band is detected. In this case, the mobile terminal displays a service unavailable message.

Once the cell searching procedure starts, the mobile terminal determines whether the ACQ DB exists in step S105. If no ACQ DB exists, the mobile terminal performs a first scan (raw scan) in step S107. During the first scan, the mobile terminal performs scanning of all frequency bands. Here, the scanning is performed in 5 MHz increments, i.e. each frequency band is 5 MHz. Next, the mobile station performs the second scan (fine scan) in step S109. In the second scan, the mobile station acquires the center frequencies of the frequency bands detected in the first scan. In the first scan, the mobile terminal recognizes distribution of the frequency bands roughly but does not recognize precise center frequencies of the respective bands. Accordingly, the mobile terminal performs the second scan for acquiring the center frequencies of the frequency bands detected in the first scan.

If it is determined that an ACQ DB exists at step S105, the mobile station determines the frequencies listed in the ACQ DB and selects one of them in step S111. Through step S109 or S111, the mobile station determines a frequency in step S113 and performs a frequency authentication in step S115. The frequency authentication is performed to determine whether the frequency is available. In order to determine whether the frequency is available, the mobile terminal transmits a signal over the frequency and waits for a reply from a base station. Next, the mobile station determines whether the frequency authentication succeeds or fails in step S117. In the case that the mobile terminal should perform the first and second scans in steps S107 and S109 without referring to the ACQ DB, the mobile terminal may repeat certain of these processes. For example, the mobile terminal may repeat the selecting of another one of frequency bands detected in the first scan after determining the center frequency of the selected frequency band in step S109, determining the frequency in step S113, and authenticating the frequency in step S117. In this illustrated example, the explanation is focused on the procedure with the ACQ DB after the frequency authentication is failed.

When the frequency authentication fails in step S117, the mobile station determines whether the current frequency is the least recent frequency of the ACQ DB in step S119. That is, the mobile station determines if the current frequency is the last frequency listed in the ACQ DB. If the current frequency is not the least recent frequency, the mobile station selects a next recent frequency from the ACQ DB in step S111. In contrast, if the current frequency is the least recent frequency, the mobile station determines if the number of the ACQ DB loops or iterations is greater than a threshold in step S121. For example, the mobile station determines if there has been N number of searching attempts.

The threshold is set for limiting a number of ACQ DB based cell searching times and may be determined by a system operator in consideration of the terminal characteristics, environmental characteristics and the like. The cell searching is repeated in association with all frequencies listed in the ACQ DB.

If the number of the ACQ loops is greater than the limit value, the mobile station performs the scanning procedure (S107 and S109) and, otherwise, increases the number of ACQ loops by one in step S122 and starts a timer 162 in step S123.

Next, the mobile terminal determines repeatedly determines whether the timer 162 has expired in step S125. When the timer 162 has expired, the mobile terminal initiates the cell searching again in step S103.

Returning to step S117, if the frequency authentication succeeds, the mobile station updates the ACQ DB using the information obtained during the authentication process in step S127 and camps onto the base station, i.e., establishes a communication channel with the base station in step S129. Consequently, the mobile station is served by the base station in step S131.

FIG. 5 is a flowchart illustrating an exemplary camping-on procedure of FIG. 4 in more detail.

Referring to FIG. 5, after establishing a communication channel with the base station, the mobile terminal receives system information from the base station in step S201. The system information may be received through the MIB and SIBs, e.g. SIB1, SIB3, and SIB11. The SIB contains system information specified in the 3GPP standards.

Next, the mobile terminal extracts the frequency, PLMN ID, cell ID, and cell access restriction information from the system information and determines whether the system information is available in step S203. That is, the mobile terminal determines whether the service provider to which the user subscriber is connected is through a valid base station. For this judgment, the mobile terminal compares the system information such as cell ID and PLMN ID with those stored in the ACQ DB in step S205. If it is determined that the base station is available as a result of the comparison, the mobile terminal performs a cell selection procedure in step S207.

During the cell selection procedure, the mobile terminal measures the service quality and received signal strength of the cell and evaluates whether the measured service quality and received signal strength are greater than threshold values. The threshold values depend on the communication protocol and are determined in consideration of the least signal characteristic requirements for communication. If it is determined that the service quality and received signal strength are sufficient, the mobile station camps onto the base station in step S209.

Alternatively, if it is determined in step S205 that the system information received from the base station is invalid, the mobile terminal returns to step S103 to perform the cell searching process again. At this time, the system information, i.e., the cell frequency and PLMN ID, received from the base station is discarded.

As described above, an exemplary cell searching method and mobile terminal therefor performs a cell searching on the basis of previously acquired authentication information prior to scan all frequency bands, thereby reducing the time spent on cell searching and improving overall cell selection efficiency.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

As described above, the cell searching method and mobile terminal according to the present invention improves the cell searching efficiency by utilizing previously acquired authentication information on the base stations.

What is claimed is:

1. A cell searching method of a mobile terminal, comprising:
determining whether authentication information of at least one cell exists in a memory;
selecting, when the authentication information exists, the authentication information of the at least one cell;
evaluating validity of the selected authentication information; and
attempting to camp onto the at least one cell using the selected authentication information if the validity evaluation is successful.

2. The cell searching method of claim 1, wherein the authentication information is listed in an ascending order of most recently used to least recently used.

3. The cell searching method of claim 2, wherein the selecting of the authentication information comprises selecting the authentication information in an order of most recently updated to least recently updated.

4. The cell searching method of claim 1, wherein the evaluating of the validity of the selected authentication information comprises performing, when the selected authentication information is invalid, validation on the authentication information of another cell.

5. The cell searching method of claim 4, wherein the evaluating of the validity of the selected authentication information further comprises:
starting, when all the selected authentication information is invalid, a timer; and
re-evaluating, when the timer has expired, the validity of the authentication information.

6. The cell searching method of claim 5, wherein the evaluating of the validity of the selected authentication information further comprises:
counting a number of running times of the timer;
scanning, when a number of running times of the timer is greater than a preset value, frequency bands;
scanning for a center frequency of each frequency band detected by the previous scanning; and
performing frequency authentication of the center frequency of each detected frequency.

7. The cell searching method of claim 6, wherein the evaluating of the validity of the selected authentication information further comprises:
extracting frequency and public land mobile network identity (PLMN ID) from the authentication information; and
comparing frequency and PLMN ID received from the cell with the extracted frequency and PLMN ID.

8. The cell searching method of claim 7, wherein the evaluating of the validity of the selected authentication information further comprises updating a priority of the authentication information of the selected cell higher than those of the other cells.

9. The cell searching method of claim 1, wherein the determining of whether the authentication information of the at least one cell exists is performed when the mobile terminal is first turned on or enters a service area.

10. A mobile terminal comprising:
a memory unit for storing authentication information of at least one cell for use in a cell searching;
a control unit for selecting authentication information of the at least one cell, for evaluating validity of the authentication information, and for attempting to camp onto the cell using the authentication information, if valid; and
a radio frequency unit for establishing a communication channel with the cell on the basis of the authentication information.

11. The mobile terminal of claim 10, wherein the authentication information is listed in an ascending order of most recently used to least recently used.

12. The mobile terminal of claim 11, wherein the control unit selects the authentication information in an order of the most recently updated to least recently updated.

13. The mobile terminal of claim 10, wherein the control unit evaluates, if the authentication information of the cell is invalid, the authentication information of another cell.

14. The mobile terminal of claim 13, wherein the control unit comprises a timer for defining a cell searching interval.

15. The mobile terminal of claim 14, wherein the control unit performs the evaluation on the authentication information again when the timer has expired.

16. The mobile terminal of claim 15, wherein the control unit counts a number of running times of the counter and, when the number of running times of the counter is greater than a preset value, performs frequency band scanning, center frequency scanning, and authentication of the center frequencies.

17. The mobile terminal of claim 16, wherein the control unit extracts frequency and PLMN ID from the authentication information and compares frequency and PLMN ID received from the cell with the extracted frequency and PLMN ID.

18. The mobile terminal of claim 17, wherein the control unit updates, when the authentication information of the cell is valid, a priority of the authentication information higher than those of the other cells.

19. The mobile terminal of claim 10, wherein the control unit performs a cell searching when the mobile terminal is first turned on or enters a service area.
